(19) United States
(12) Patent Application Publication
(10) Pub. No.: US 2007/0013481 A1
(43) Pub. Date: Jan. 18, 2007

(54) Method and apparatus for battery power conservation in tags

(75) Inventors: Liping Julia Zhu, San Jose, CA (US); Roderick E. Thorne, Palo Alto, CA (US)

Correspondence Address: HAYNES AND BOONE, LLP, 901 MAIN STREET, SUITE 3100, DALLAS, TX, 75202, US

(73) Assignee: Savi Technology, Inc., Sunnyvale, CA (US)

(21) Appl. No.: 11/266,019

(22) Filed: Nov. 3, 2005

Related U.S. Application Data
(60) Provisional application No. 60/693,200, filed on Jun. 23, 2005.

(51) Int. Cl. H04Q 5/22

(52) U.S. Cl. 340/10.1

(57) ABSTRACT

A tag has first and second modes of operation, and uses substantially less battery power in the first mode. In the first mode, the tag is responsive to receipt of a first wireless signal from a remote location with a first transmission range for shifting to the second mode. In the second mode, the tag transmits a second wireless signal with a second transmission range. In one configuration, the second transmission range is greater than or equal to the first transmission range. In a different configuration, the tag periodically checks for the first wireless signal during the first mode at points in time spaced by a time interval. The second transmission range is less than the first transmission range by a difference that is greater than or equal to the time interval multiplied by a speed of movement of the tag toward the remote location.

This application claims the priority under 35 U.S.C. §119 of U.S. provisional application No. 60/693,200 filed Jun. 23, 2005, the disclosure of which is hereby incorporated herein by reference.

### FIELD OF THE INVENTION

This invention relates in general to radio frequency identification tags and, more particularly, to techniques for conserving battery power in tags.

### BACKGROUND

A known technique for tracking items is to mount a radio frequency identification (RFID) tag on each item to be tracked. These RFID tags transmit wireless signals, and readers are provided to receive these signals. RFID tags almost always run on battery power. Consequently, it is always desirable to conserve a tag's battery power, in order to maximize the length of time from insertion of a newly-charged battery until the battery becomes too discharged to properly operate the tag. Existing techniques for conserving battery power have been generally adequate for their intended purposes, but have not been satisfactory in all respects.

### SUMMARY OF THE INVENTION

One of the broader forms of the invention relates to a tag having a battery and having first and second operational modes that are different, the tag using substantially less power from the battery in the first operational mode than in the second operational mode. This form of the invention includes: responding to receipt by the tag in the first operational mode of a first wireless signal originating from a remote location and having a first transmission range by shifting the tag from the first operational mode to the second operational mode; and transmitting from the tag in the second operational mode a second wireless signal that is different from the first wireless signal and that has a second transmission range greater than or equal to the first transmission range.

Another of the broader forms of the invention relates to a tag having a battery and having first and second operational modes that are different, the tag using substantially less power from the battery in the first operational mode than in the second operational mode. This form of the invention includes: moving the tag relative to a remote location so that the tag has a speed of movement toward the remote location; periodically checking during the first operational mode at points in time spaced by a time interval for receipt by the tag of a first wireless signal originating from the remote location and having a first transmission range; responding to receipt by the tag in the first operational mode of the first wireless signal by shifting the tag from the first operational mode to the second operational mode; and transmitting from the tag in the second operational mode a second wireless signal that is different from the first wireless signal and that has a second transmission range less than the first transmission range, the difference between the first and second transmission ranges being greater than or equal to the time interval multiplied by the speed of movement.

### BRIEF DESCRIPTION OF THE DRAWINGS

A better understanding of the present invention will be realized from the detailed description that follows, taken in conjunction with the accompanying drawings, in which:

FIG. 1 is a diagrammatic top view of an apparatus that embodies aspects of the invention, and that includes a reader and a plurality of shipping containers with radio frequency identification tags thereon.

FIG. 2 is a diagrammatic top view of a further apparatus that embodies aspects of the invention, and that is an alternative embodiment of the apparatus of FIG. 1.

### DETAILED DESCRIPTION

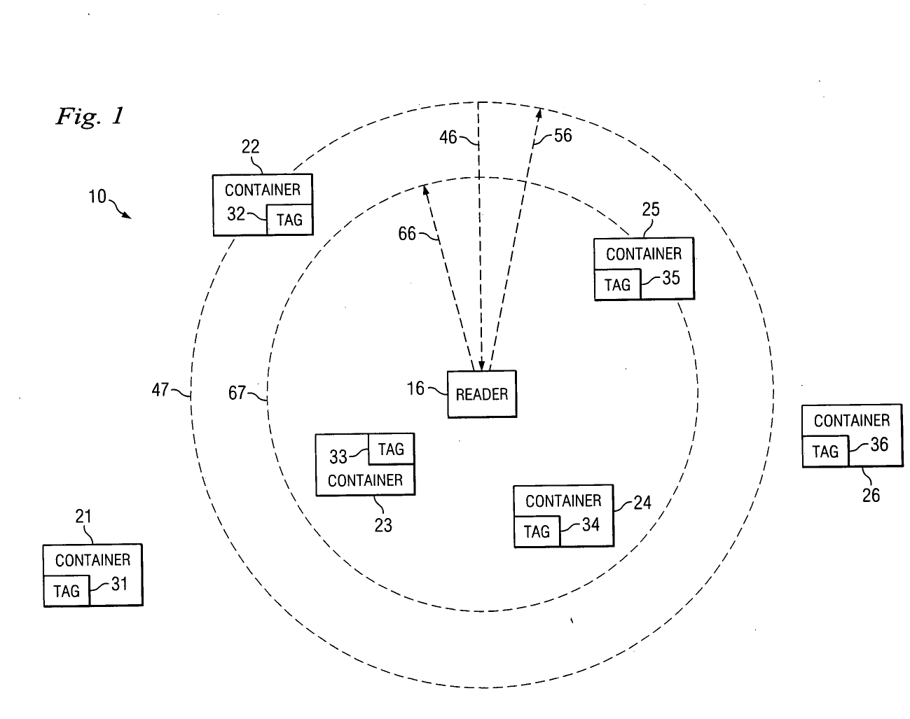

FIG. 1 is a diagrammatic top view of an apparatus that embodies aspects of the invention, and that includes a reader 16, a plurality of members 21-26, and a plurality of radio frequency identification (RFID) tags 31-36. In FIG. 1, the members 21-26 are each a shipping container of a known type. The reader 16 is stationarily supported, and the shipping containers 21-26 are disposed at various locations around the reader 16. Although the shipping containers 21-26 are capable of being transported to and from the locations shown in FIG. 1, for the sake of simplicity in the discussion that follows, the containers 21-26 are each assumed to be stationary. The environment shown in FIG. 1 may, for example, be be a yard located adjacent to a factory. Shipping containers filled with component parts are delivered to the yard, and then sit and wait within the yard until the component parts therein are needed for use in making products in the factory.

The RFID tags 31-36 are each a battery-operated device that is mounted on a respective one of the shipping containers 21-26. Each tag has multiple operating modes, including a sleep mode and an active mode. In the sleep mode, most of the circuitry within the tag is disabled, so that the tag draws very little power from its battery. The sleep mode thus helps to maximize the operational life of the battery, or in other words the time interval from installation of a fully charged battery until that battery is too discharged to properly and reliably operate the tag. In the active mode, more of the circuitry within the tag receives operating power, and the tag is capable of transmitting a wireless tag signal that contains an identification code unique to that particular tag.

The tags 31-36 can each transmit the wireless tag signal with a power level that provides a distance or range indicated diagrammatically in FIG. 1 by the length of a broken-line arrow 46. A broken-line circle 47 extends around that reader 16, and has a radius equal to the length of the arrow 46. Thus, when a tag is located inside the circle 47, tag signals transmitted by the tag will be received by the reader 16. On the other hand, when a tag is located outside the circle 47, the reader 16 will not receive tag signals transmitted by that tag, because the reader 16 is beyond the range of those wireless signals. As evident from FIG. 1, two tags 31 and 36 are at locations where their wireless tag signals will not reach the reader 16, and four tags 32-35 are at locations where their wireless tag signals will reach the reader 16.

The reader 16 is capable of transmitting a wireless wakeup signal to any tag 31-36 that is currently within the range of the wakeup signal. The International Organization for Standardization (ISO) has promulgated an international standard for active RFID that is known in the art as ISO 18000-7. According to this standard, a wakeup signal is a 30 KHz single tone waveform with a duration of at least 2.5 seconds. The tags 31-36 are each configured so that, when they are in the sleep mode, they periodically check for this 30 KHz wakeup signal. According to ISO 18000-7, the tags check for the wakeup signal at points in time spaced by time intervals of no more than 2.5 seconds. If a tag detects the presence of the wireless wakeup signal, the tag shifts from its sleep mode to its active mode, and then transmits its tag signal.

If the wakeup signals from the reader 16 were transmitted with the same power level as the tag signals from the tags 31-36, it would be easier for the tags to detect the wakeup signal than for the tags to reliably deliver a tag signal to the reader 16. Stated differently, the wakeup signals and the tag signals have different effective ranges, even if their power levels are the same. Consequently, the discussion that follows will tend to focus more on effective ranges than on specific power levels.

It would be possible for the reader 16 to transmit its wireless wakeup signals with a relatively high power level, so that each wakeup signal has a long range that is sufficient to reach all of the tags 31-36 shown in FIG. 1. However, as discussed above, the tag signals are transmitted by the tags with a power level that provides the effective range represented by the length of the arrow 46. Thus, in FIG. 1, only the tag signals transmitted by the tags 32-35 located within the circle 47 will reach the reader 16. If the reader 16 transmits its wakeup signal with a high power level that is sufficient to reach the tags 31 and 36, then the tags 31 and 36 will shift from the sleep mode to the active mode, and will transmit their tag signals. However, this wastes power from the batteries in the tags 31 and 36, because these tags are outside the circle 47, and the reader 16 will therefore not receive any of the tag signals they transmit.

Accordingly, to avoid unnecessary waste of battery power, the reader 16 transmits its wireless wakeup signal with a power level selected so that the effective range 56 of the wakeup signal is approximately equal to (but no greater than) the effective range 46 of the tag signals. Thus, the wakeup signal will wake up the tags 32-35 that are within the circle 47 and that are capable of delivering a wireless tag signal to the reader 16. However, the wakeup signal will not wake up the tags 31 and 36 that are outside the circle 47 and that cannot transmit a tag signal far enough to reach the reader 16.

As an alternative, the reader 16 can be configured to transmit its wireless wakeup signal with a power level having an effective range 66 that is represented diagrammatically by the circle 67, and that is slightly less then the range 46 of the tag signals. In that case, the wakeup signal will wake up the three tags 33-35 that are located within the circle 67, but will not wake up the three tags 31-32 and 36 that are located outside the circle 67. This ensures that each tag receiving the wakeup signal is located where it will be able to reliably deliver its tag signal to the reader 16.

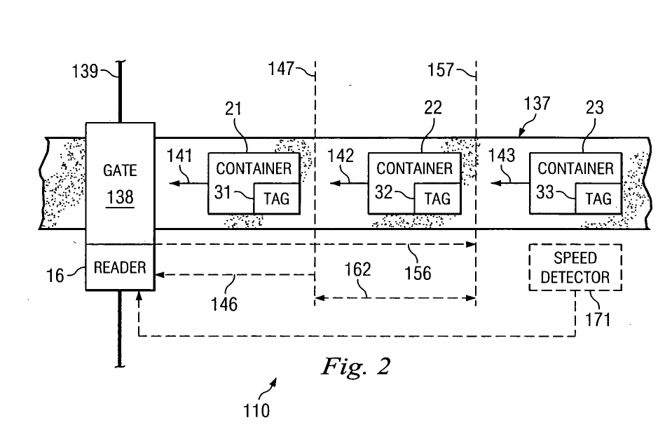

FIG. 2 is a diagrammatic top view of an apparatus 110 that embodies aspects of the invention, and that is an alternative embodiment of the apparatus 10 of FIG. 1. The apparatus 110 of FIG. 2 includes a reader 16, and three shipping containers 21-23 that each support a respective RFID tag 31-33. The reader 16, containers 21-23 and tags 31-33 are equivalent to their counterparts in the embodiment of FIG. 1, and are therefore identified with the same reference numerals.

A fence 139 has a gate 138, and a road 137 extends through the gate 138. The reader 16 is mounted on or adjacent the gate 138. The containers 21-23 move along the road 137 in a direction generally toward the gate 138 and the reader 16, as indicated diagrammatically by arrows 141-143. For example, the containers 21-23 may each be supported on a respective vehicle that is not illustrated, such as a truck.

The tag signals transmitted by the tags 31-33 have a transmission range that is indicated diagrammatically by the length of an arrow 146. Stated differently, the reader 16 is capable of receiving a tag signal transmitted by a tag when the tag is located between the reader 16 and a line 147. The reader 16 transmits its wireless wakeup signal with a power level that provides an effective range indicated diagrammatically by the length of a broken-line arrow 156. Thus, a tag can receive the wakeup signal if the tag is located between the reader 16 and a line 157.

In the embodiment of FIG. 1, the transmission range 56 of the wireless wakeup signals was selected to be less than or equal to the transmission range 46 of the tag signals. In contrast, in the embodiment of FIG. 2, the transmission range 156 of the wakeup signals is selected to be greater then the transmission range 146 of the tag signals. The transmission range 156 exceeds the transmission range 146 by a distance that is indicated diagrammatically by the length of a double-headed arrow 162. More specifically, the distance 162 is selected to be equal to the speed of movement of the containers 21-23, multiplied by the time interval between the periodic checks by the tags 31-33 for the presence of the wakeup signal. Stated differently, the distance 162 is the distance that each of the tags 31-33 will travel during the time interval between two successive checks by that tag for the presence of the wakeup signal. Consequently, each of the moving tags 31-33 will detect one of the periodic wakeup signals at some point while the tag is traveling between the lines 147 and 157. Each of the tags will thus be in the active mode and transmitting its tag signal by the time it reaches the line 147.

Since the tags 31-33 are all moving, and will eventually travel through the gate 138 and then move away from the reader 16, there is a limited window of time available for the reader 16 to read the tag signals transmitted by each of the tags 31-33. As discussed above, each tag will be active and transmitting its tag signal by the time that it reaches the line 147. This helps to maximize the amount of time available for the reader 16 to read the tag signal transmitted by each tag. This approach also ensures that the tags do not receive the wakeup signal before they reach the line 157. Thus, they do not leave the sleep mode too early and simply waste battery power.

In the foregoing discussion of FIG. 2, it has been assumed that the containers 21-23 are all moving at approximately the same predetermined speed, for example because the road 137 has an established speed limit to which most vehicles adhere. In a variation of the embodiment of FIG. 2, a speed detector of a known type can be provided to detect the speed of each container before the container reaches the line 157, as indicated diagrammatically with broken lines at 171 in FIG. 2. The output of the speed detector 171 is supplied to the reader 16, so that the reader 16 knows the exact speed of each container as the container approaches the line 157. The reader can then dynamically change the power level of its wireless wakeup signal to adjust the effective range 156 of the wake up signal (and the position of the line 157), in a manner that is customized for each container. Stated differently, the distance 162 is customized for each container, so that the distance 162 from the line 147 is equal to the actual speed of that particular container multiplied by the time interval between successive checks by each tag for the presence of the wakeup signal.

The foregoing discussion of FIG. 2 also assumes that the tags 31-33 each check for the wakeup signal at points in time spaced by time intervals of no more than 2.5 seconds, for example as specified by the industry standard set forth in ISO 18000-7. However, in situations where compliance with ISO 18000-7 is not essential, it would be possible to dynamically vary the time interval between checks by the tags for the wakeup signal. As one example, the tags 31-33 could be programmed to use one time interval (such as 1 second) during the day, and a different time interval (such as 2 seconds) at night. The reader would then use the current time of day to dynamically adjust the power level of its wakeup signal, and thus the effective range 156 of the wakeup signals, so that the distance 162 is consistent with the time interval currently being used by the tags 31-33.

As discussed above, the members 21-26 in the disclosed embodiments are shipping containers. However, the members 21-26 could alternatively be any of a variety of other types of members, such as shipping pallets, or individual items that are being tracked. In the embodiment of FIG. 2, the containers 21-23 are supported on not-illustrated vehicles that are moving along a road 137. However, the approach described in association with FIG. 2 can be applied to other scenarios. For example, a moving conveyor could be provided instead of the road 137, and the containers 21-23 could be supported on the conveyor. The conveyor would move the containers past the stationary reader 16.

Although selected embodiments have been illustrated and described in detail, it should be understood that a variety of substitutions and alterations are possible without departing from the spirit and scope of the present invention, as defined by the following claims.

What is claimed is:

1. An apparatus comprising:
a tag having a battery and having first and second operational modes that are different, said tag using substantially less power from said battery in said first operational mode than in said second operational mode;
wherein in said first operational mode said tag is responsive to receipt of a first wireless signal originating from a remote location and having a first transmission range for shifting from said first operational mode to said second operational mode; and
wherein in said second operational mode said tag transmits a second wireless signal that is different from said first wireless signal and that has a second transmission range greater than or equal to said first transmission range.

2. An apparatus according to claim 1, wherein said tag is substantially stationary relative to said remote location.

3. An apparatus according to claim 2, including a reader that is disposed at said remote location, and that transmits said first wireless signal.

4. An apparatus according to claim 1, including:
a further tag having a further battery and having third and fourth operational modes that are different, said further tag using substantially less power from said further battery in said third operational mode than in said fourth operational mode;
wherein in said third operational mode said further tag is responsive to receipt of said first wireless signal for shifting from said third operational mode to said fourth operational mode; and
wherein in said fourth operational mode said further tag transmits a third wireless signal that is different from said first and second wireless signals and that has a third transmission range greater than or equal to said first transmission range.

5. An apparatus according to claim 4, wherein said tags are each substantially stationary relative to said remote location.

6. An apparatus according to claim 5, including a reader that is disposed at said remote location, and that transmits said first wireless signal.

7. An apparatus according to claim 4, including first and second shipping containers that respectively have said first and second tags supported thereon.

8. An apparatus comprising:
a tag having a battery and having first and second operational modes that are different, said tag using substantially less power from said battery in said first operational mode than in said second operational mode;
wherein in said first operational mode said tag periodically checks at points in time spaced by a time interval for a first wireless signal originating from a remote location and having a first transmission range, said tag being responsive to receipt of said first wireless signal for shifting from said first operational mode to said second operational mode; and
wherein in said second operational mode said tag transmits a second wireless signal that is different from said first wireless signal and that has a second transmission range less than said first transmission range, the difference between said first and second transmission ranges being greater than or equal to said time interval multiplied by a speed of movement of said tag relative to and in a direction toward said remote location.

9. An apparatus according to claim 8, including a reader that is disposed at said remote location, and that transmits said first wireless signal.

10. An apparatus according to claim 9, wherein said reader varies a transmission power level of said first wireless signal as a function of said speed of movement.

11. An apparatus according to claim 10,
wherein said reader is stationary; and
including a speed detector that detects a speed of movement of said tag, said reader effecting said variation of said transmission power level as a function of an output of said speed detector.

12. An apparatus according to claim 8, wherein said tag varies said time interval as a function of a selected criterion.

13. An apparatus according to claim 8, including:
a further tag having a further battery and having third and fourth operational modes that are different, said further tag using substantially less power from said further battery in said third operational mode than in said fourth operational mode;
wherein in said third operational mode said further tag periodically checks at points in time spaced by said time interval for said first wireless signal, said further tag being responsive to receipt of said first wireless signal for shifting from said third operational mode to said fourth operational mode; and
wherein in said fourth operational mode said further tag transmits a third wireless signal that is different from said first and second wireless signals and that has a third transmission range less than said first transmission range, the difference between said first and third transmission ranges being greater than or equal to said time interval multiplied by a speed of movement of said further tag relative to and in a direction toward said remote location.

14. An apparatus according to claim 13, including a reader that is disposed at said remote location, and that transmits said first wireless signal.

15. An apparatus according to claim 14, wherein said reader varies a transmission power level of said first wireless signal as a function of said speed of movement of at least one of said tags.

16. An apparatus according to claim 15,
wherein said tags move successively along a path of movement; and
wherein said reader effects said variation of said transmission power level independently for each said tag as a function of a respective said speed of movement for each said tag.

17. An apparatus according to claim 16,
wherein said reader is stationary; and
including a speed detector that detects the respective speed of movement of each said tag, said reader effecting said variation of said transmission power level as a function of an output of said speed detector.

18. An apparatus according to claim 13, including first and second shipping containers that respectively have said first and second tags supported thereon.

19. A method comprising:
providing a tag having a battery and having first and second operational modes that are different, said tag using substantially less power from said battery in said first operational mode than in said second operational mode;
responding to receipt by said tag in said first operational mode of a first wireless signal originating from a remote location and having a first transmission range by shifting said tag from said first operational mode to said second operational mode; and
transmitting from said tag in said second operational mode a second wireless signal that is different from said first wireless signal and that has a second transmission range greater than or equal to said first transmission range.

20. A method according to claim 19, including transmitting said first wireless signal from a reader disposed at said remote location, said tag being substantially stationary relative to said reader.

21. A method according to claim 19, including:
providing a further tag having a further battery and having third and fourth operational modes that are different, said further tag using substantially less power from said further battery in said third operational mode than in said fourth operational mode;
responding to receipt by said further tag in said third operational mode of said first wireless signal by shifting said further tag from said third operational mode to said fourth operational mode; and
transmitting from said further tag in said fourth operational mode a third wireless signal that is different from said first and second wireless signals and that has a third transmission range greater than or equal to said first transmission range.

22. A method according to claim 21, including transmitting said first wireless signal from a reader disposed at said remote location, said tags each being substantially stationary relative to said reader.

23. A method according to claim 21, including supporting said tags on respective shipping containers.

24. A method comprising:
providing a tag having a battery and having first and second operational modes that are different, said tag using substantially less power from said battery in said first operational mode than in said second operational mode;
moving said tag relative to a remote location so that said tag has a speed of movement toward said remote location;
periodically checking during said first operational mode at points in time spaced by a time interval for receipt by said tag of a first wireless signal originating from said remote location and having a first transmission range;
responding to receipt by said tag in said first operational mode of said first wireless signal by shifting said tag from said first operational mode to said second operational mode; and
transmitting from said tag in said second operational mode a second wireless signal that is different from said first wireless signal and that has a second transmission range less than said first transmission range, the difference between said first and second transmission ranges being greater than or equal to said time interval multiplied by said speed of movement.

25. A method according to claim 24, including transmitting said first wireless signal from a reader disposed at said remote location.

26. A method according to claim 25, including varying a transmission power level of said first wireless signal as a function of said speed of movement.

27. A method according to claim 24, including varying said time interval as a function of a selected criterion.

28. A method according to claim 24, including:
providing a further tag having a further battery and having third and fourth operational modes that are different, said further tag using substantially less power from said further battery in said third operational mode than in said fourth operational mode;
moving said further tag relative to said remote location so that said further tag has a speed of movement toward said remote location;
periodically checking during said third operational mode at points in time spaced by said time interval for receipt by said further tag of said first wireless signal;
responding to receipt by said further tag in said third operational mode of said first wireless signal by shifting said further tag from said third operational mode to said fourth operational mode; and
transmitting from said further tag in said fourth operational mode a third wireless signal that is different from said first and second wireless signals and that has a third transmission range less than said first transmission range, the difference between said first and third transmission ranges being greater than or equal to said time interval multiplied by said speed of movement of said further tag.

29. A method according to claim 28, including transmitting said first wireless signal from a reader disposed at said remote location.

30. A method according to claim 29, including varying a transmission power level of said first wireless signal as a function of said speed of movement of at least one of said tags.

31. A method according to claim 30,
wherein said moving of each of said tags is carried so that said tags move successively along a path of movement; and
wherein said varying of said transmission power level by said reader is carried out independently for each said tag as a function of the respective said speed of movement of each said tag.

32. A method according to claim 28, including supporting said tags on respective shipping containers.
